(19) United States
(12) Patent Application Publication
(10) Pub. No.: US 2019/0258396 A1
(43) Pub. Date: Aug. 22, 2019

(54) LAYOUT DESIGN WITH ADAPTIVE AREAS

(71) Applicant: ADOBE INC., San Jose, CA (US)

(72) Inventor: John Paul Barrick, Olympia, WA (US)

(21) Appl. No.: 15/899,781

(22) Filed: Feb. 20, 2018

(51) Int. Cl. G06F 3/0488; G06F 3/0484

(52) U.S. Cl. CPC G06F 3/04886; G06F 2203/04803; G06F 3/0484

(57) ABSTRACT

Techniques for layout design are disclosed. A page or a part of the page has different areas. A layout is formed by dividing an area into subareas in the layout direction. A subarea may inherit the layout direction or have a different layout direction for further division. The subarea may be configured as a deterministic size type or a nondeterministic size type. The resulting layout has a natural layout hierarchy and is versatile and adaptive for different displays.

### BACKGROUND

Graphic design is a type of visual communication using typography, photography, and illustration. Graphic designers may use visual arts, typography, and page layout techniques to create visual compositions. Page layout is a part of graphic design generally directed to the arrangement of visual elements on a page.

Traditional page layout techniques usually are cumbersome. For example, to generate a page layout using conventional systems, the details of each part of the layout need to be specified. Further, conventional page layout techniques oftentimes produce static areas in a layout, which may cause inconsistent presentations at modem heterogenous computing devices due to their different display sizes, resolutions, or orientations. For example, a page layout may appear one way when displayed on one device, but may appear another way when displayed on another device. Further, it is a challenge to design page layouts that can properly function on modem devices with smaller and rotatable displays, such as smartphones.

### SUMMARY

Embodiments of the present disclosure relate to systems and methods for layout design. As such, among many aspects of the present disclosure, one aspect is to enable a layout to be versatile and adaptive for diverse displays. In particular, in accordance with embodiments described herein, a layout can dynamically adapt based on a user interaction or a specific display on which the layout is presented.

To enable such an adaptive layout, as described in embodiments herein, adaptive areas and configurable layout directions are utilized. In this regard, the layout direction of an area can be configured, and the area can automatically adapt to different displays. In one embodiment, to generate the layout, each area (e.g., rectangle) can be divided into subareas having an associated direction. The layout direction of a subarea may be inherited from its parent or reconfigured to be different from its parent. The size type of the subarea may be a deterministic size type or a nondeterministic size type. The deterministic size type may have a deterministic size, such as related to actual pixels on the screen, the physical size of the screen, or the size of the parent area, in the layout direction of the parent area. The nondeterministic size type may have a nondeterministic size in at least one dimension of the area. Typically, the nondeterministic size type will allow the area to take a share of the remaining unallocated space of the parent area. Collectively, areas in different size types enable a layout to be versatile and adaptive to diverse displays or user interface changes.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

Embodiments will be readily understood by the following detailed description in conjunction with the accompanying drawings.

FIG. 1 is a schematic diagram illustrating an example implementation of a system for layout design, incorporating aspects of the present disclosure, in accordance with one embodiment.

FIG. 2 is a schematic diagram illustrating an example layout design, incorporating aspects of the present disclosure, in accordance with one embodiment.

FIG. 3 is a schematic diagram illustrating another example layout design, incorporating aspects of the present disclosure, in accordance with one embodiment.

FIG. 4 is a flow diagram of an example process for layout design, incorporating aspects of the present disclosure, in accordance with one embodiment.

FIG. 5 is a flow diagram of another example process for layout design, incorporating aspects of the present disclosure, in accordance with one embodiment.

FIG. 6 illustrates an example computing device suitable for practicing the disclosed embodiments, in accordance with one embodiment.

### DETAILED DESCRIPTION

User interface (UI) layout is a type of layout, which is directed to the placement of graphical or non-graphical elements on a user interface. UI layout accommodates the visual presentation or communication of graphical interface elements, and also facilitates user interactions with different elements on the user interface. In this regard, UI layout is a communication tool as well as a problem-solving tool for modern computing. The term UI layout and layout are used interchangeably hereinafter.

Some operating systems, programming libraries, or graphic user interface (GUI) toolkits may provide a software component, e.g., a layout manager, to facilitate applications to generate layouts with a common look and feel. Typically, such a layout manger is configured to receive layout instructions from applications and divide the user interface into a set of areas.

A designer may use Hypertext Markup Language (HTML) or other markup languages to create simple web page layouts. For example, HTML tables were used to layout simple web pages in earlier days of the Internet. A designer may also use style languages or style sheet languages to create more sophisticated web page layouts. One example of a widespread style sheet language is Cascading Style Sheets (CSS), which is used to style documents written in HTML, Scalable Vector Graphics (SVG), and other markup languages. Different style sheets can be used to produce different layouts.

Utilization of such markup languages or style sheets, and other traditional layout techniques, are usually difficult for novice designers. Such conventional layout techniques usually yield fixed size allocations to subareas in a layout design. Problematically, fixed allocations in layout design may introduce inconsistent layout behavior across heterogenous computing devices, especially for modern smaller and rotatable displays, which may vary dramatically in their display sizes, resolutions, aspect-ratios, orientations, etc.

In this disclosure, technical solutions are provided to enable a layout to be versatile and adaptive to diverse displays or UI changes. An adaptive layout includes the composition of different areas in fixed size or adaptive size. To accomplish an adaptive layout design, the layout is generally generated by recursively dividing areas into subareas with different size types in one or more layout directions. At a high level, and as described in reference to illustrative embodiments, the size type of an area may be a deterministic size type or a nondeterministic size type. The layout direction of the area may be inherited from its parent or defined to be different from its parent. Noticeably, the layout direction of an area does not apply to the area itself, but applies to its immediate children, and may be inherited by a descendant area if a new layout direction is not specified for the descendant area.

The versatility of adaptive areas, redefining the size type for any areas, or changing the layout direction for any areas enables the resulting layout to be versatile and adaptive to diverse displays or changes. By way of example, a layout can dynamically adapt to different devices, e.g., by reconfiguring the arrangement of areas in the layout based on the size, resolution, orientation, etc. of the display. For instance, when switching to a smaller display, the areas with the nondeterministic size type can shrink to adapt to the smaller display. Vice versa, when switching to a larger display, the areas with the nondeterministic size type can automatically enlarge to fill the added space in the larger display. For another example, when a user changes the orientation of a mobile device, the layout can dynamically adapt to the new orientation, e.g., by changing the shapes and sizes of subareas to fit with the new orientation. This and other aspects of the disclosure will be further discussed in connection with figures herein.

In one embodiment, the UI is divided into rectangular regions called areas. For example, an initial area within a UI might be a window. Within the initial area, the layout direction is specified as either horizontal or vertical. Along the layout direction, the area is divided into subareas. For example, for a vertical layout, one subarea can be positioned on top of another subarea, taking up maximum width of the parent area. For a horizontal layout, subareas will be positioned from left to right, taking up maximum height of the parent area. Within each subarea, the layout direction may be changed and the subarea may be recursively subdivided into smaller subareas. The size type of the subarea can be a deterministic size type or a nondeterministic size type. If the size type is not specifically defined, the default size type (e.g., a nondeterministic size type) may be used. Such subareas can then be used to form a dynamic layout, e.g., adaptive to various displays.

Traditional technologies for layout are convoluted. By way of example, HTML has a structure and an inferred layout. CSS is required to advance the HTML layout for more complex or expressive results. This requires at least two separate document types which are interdependent for complex layout. Additionally, the HTML/CSS technology often require additional technologies, such as a CSS pre-processor or JavaScript program that actively modifies the layout. Advantageously, the disclosed layout techniques herein can generate a dynamic layout without additional technologies. The disclosed layout techniques can operate independently, and can be quickly learned by designers to create versatile layouts according to different layout requirements. The resulting layout forms a natural layout hierarchy, and each area can contain a different layout paradigm. Such dynamic layouts can adapt to diverse displays and be used by various applications to provide consistent and predictable layouts.

Various terms are used throughout this description. Definitions of some terms are included below to provide a clearer understanding of the ideas disclosed herein.

The term “layout”, “user interface layout”, or “UI layout” generally refers to layout design related to the arrangement of graphical and non-graphical elements or components on a user interface. The graphical interface elements may include visible UI elements, such as windows, menus, controls, informational elements, etc. Controls may include input controls, such as check boxes, radio buttons, drop-down lists, list boxes, buttons, toggles, text fields, date field, etc. Informational elements may include tooltips, icons, progress bar, notifications, message boxes, etc. Non-graphical elements may occupy an area or a part of the area, such as margins or spacers used to separate graphical elements.

The term “area” or “subarea” refers to a bounded part of the user interface. An area or subarea usually has a geometrical shape, such as polygons, circles, ellipses, etc., which is bounded by lines or curves. “Area” and “subarea” are used interchangeably in this disclosure.

The term “deterministic size type” of an area refers to the size type having a deterministic size, such as related to actual pixels on the screen, the physical size of the screen, or the size of the parent area. Depending on the geometrical shape of the area, one or more parameters may be used to form a deterministic size type. For example, the center and the radius may be needed to define a circle area. However, for a rectangle area, the size at one dimension, e.g., the layout direction, is typically sufficient to define a rectangle area in the layout as the size at the other direction can be inherited from the parent area.

The term “nondeterministic size type” refers to the size type of an area having a nondeterministic size in at least one dimension of the area. Typically, a subarea with nondeterministic size type will be allocated a share of the remaining unallocated space of the parent area. When the parent area hosts more than one subarea with the nondeterministic size type, these sibling subareas may share the remaining unallocated space equally or follow a predetermined schema with unequal allocation.

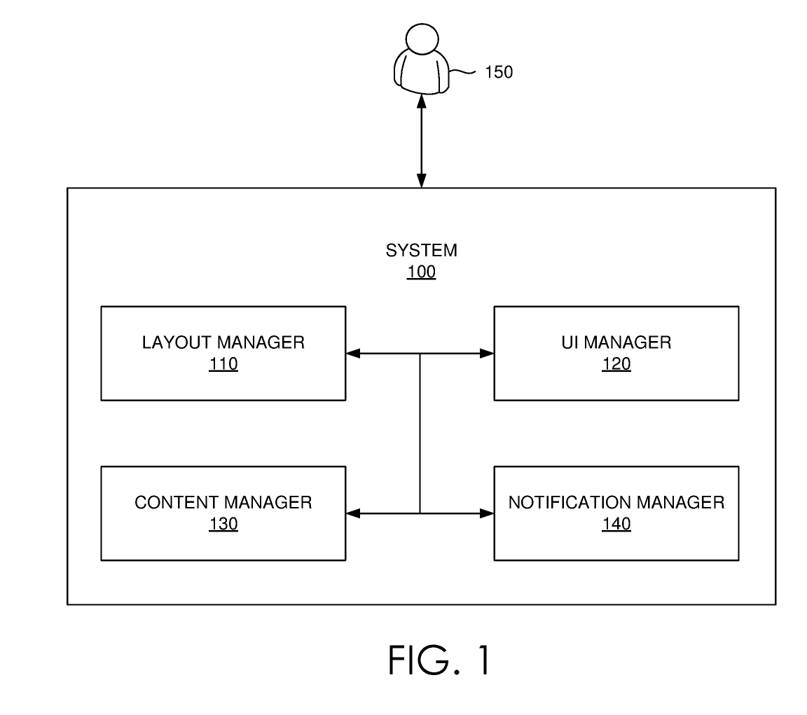

Referring now to FIG. 1, a schematic diagram illustrates an example implementation of a system for layout design. As illustrated in FIG. 1, the system for layout design includes layout manager 110, UI manager 120, content manager 130, and notification manager 140, operatively coupled with each other. In accordance with various embodiments, user 150 interacts with system 100 via various user actions. System 100 may be implemented as a subsystem in a client device. Alternatively, system 100 or one or more components in system 100 may be implemented outside of client devices, such as in a server.

Layout manager 110 enables system 100 to form a layout based on instructions of layout design. Layout instructions define how to divide an area into subareas for housing respective UI elements or content. Generally, the layout direction of the area and properties of the subarea can be configured by a layout designer in the layout instructions. Subsequently, layout manager 110 uses the layout instructions to form layouts.

In various embodiments, layout manager 110 may enable subareas to inherit various properties from the parent area. By way of example, if the layout direction is not specified for a subarea, then the subarea can inherit the layout direction of its parent area. Other properties may also be inherited, such as the visual presentation of the area, including the area background.

In various embodiments, layout manager 110 may set default values for the layout direction and various properties of subareas if such properties are not specifically defined by the designer and not inherited from the parent area. As an example, the default size type for an area may be set as the nondeterministic size type. If the size type of a subarea is not specified by the designer, layout manager 110 can assign this default size type to the subarea. As another example, the default layout direction for an area may be set as vertical. If the layout direction is not specified by the designer or inherited from the parent area, layout manager 110 can assign this default layout direction to the subarea. As yet another example, the default shape type for an area may be set as rectangle. If the shape is not specified by the designer, layout manager 110 can assign this default shape type to the subarea.

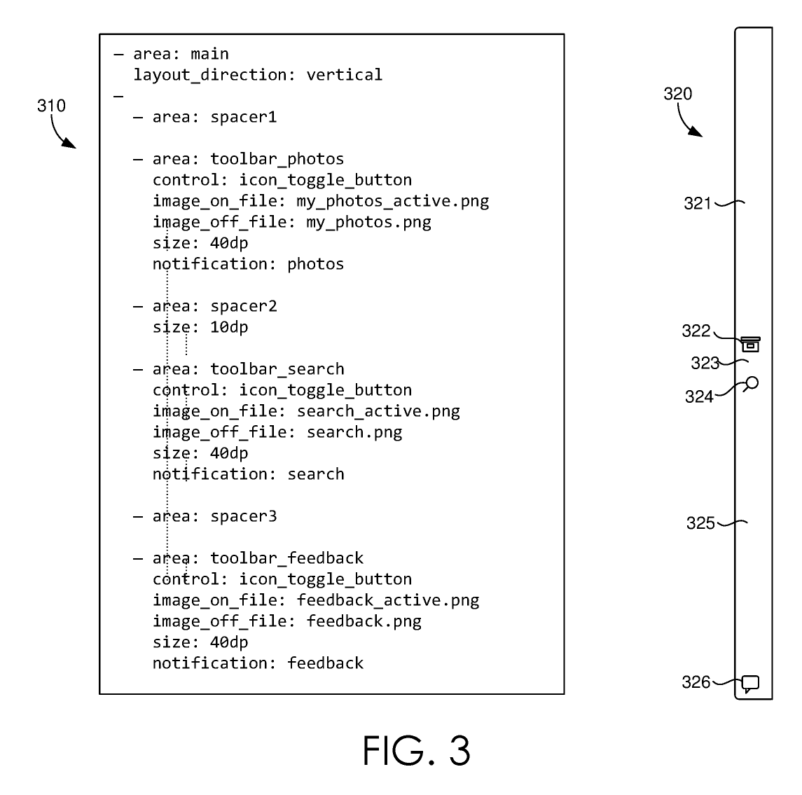

In one embodiment, layout manager 110 divides a rectangle window into subareas. Within the window, layout manager 110 adds one or more subareas along the layout direction, which may be horizontal or vertical. For the vertical layout direction, layout manager 110 may arrange subareas vertically within the window, from top to bottom. For the horizontal layout direction, layout manager 110 may arrange subareas horizontally within the window, from left to right. For a subarea with a deterministic size type, layout manager 110 can allocate the next available area with the specified size along the layout direction and the maximum size of the parent area at the dimension perpendicular to the layout direction. For a subarea with nondeterministic size type, its size at the dimension perpendicular to the layout direction will remain as the maximum size of the parent area. However, for its size in the layout direction, layout manager 110 can subtract the needs of all subareas of the deterministic size type, and divide the remainder by all subareas of the nondeterministic size type. An example of such allocation is further illustrated in FIG. 3. Within each subarea, the same process for area division may be implemented to further set up a layout direction and divide a subarea into smaller subareas.

Layout manager 110 also responds to layout changes caused by user instructions or display changes. For example, when the display changes, such as the orientation of the display changes from vertical to horizontal, layout manager 110 can re-implement the layout instructions again for the new display orientation. Specifically, the subareas in the layout may be re-arranged according to the new orientation. For instance, an area of deterministic size type may still retain its size in the layout direction, albeit its size in the other direction may change. However, the areas of nondeterministic size type may enlarge in the horizontal direction while shrink in the vertical direction to accommodate the orientation change.

As another example, a layout change to an area may trigger top-down cascading changes. For example, if the layout direction or another property of an area is changed, such change may be propagated to its child areas, grandchildren areas, and so forth based on the layout hierarchy. One exception for such top-down inheritance includes, for example, if the layout direction changed from vertical to horizontal for the parent area, and one descendant has a specific layout direction defined already, then the top-down propagation of changing the layout direction can be stopped for this particular branch at this descendant area.

A leaf area is an area without child subareas. In other words, layout manager 110 does not subdivide leaf areas. Usually, only leaf areas in a layout can host UI elements. In one embodiment, layout manager 110 calls UI manager 120 to generate UI elements for at least some of the leaf areas in the layout. In one embodiment, in a workspace or panel type layout, UI manager 120 generates a UI panel for each of the leaf areas in the layout. Each panel may be further utilized to house a particular arrangement of related information for users. In other embodiments, any area can contain visual elements.

UI manager 120 enables system 100 to manage UI elements. UI manager 120 generates and manages different UI elements, including input controls, navigational elements, informational elements, containers, etc. Input controls include check boxes, radio buttons, drop-down lists, list boxes, buttons, toggles, text fields, date field, etc. Navigational elements include breadcrumb, slider, search field, pagination, slider, tags, icons, etc. Informational elements include tooltips, icons, progress bar, notifications, message boxes, etc. Containers include accordion, etc.

UI elements may impact the layout. By way of example, some UI elements may have a minimum size. In this case, UI manager 120 may adjust the layout to accommodate the minimum size requirement of UI elements that will be generated in an area of the UI. In one embodiment, UI manager 120 will increase the size of an area to the minimum size requirement of the UI element that is housed in the area.

Content manager 130 enables system 100 to manage content presented in the UI. The content may impact the layout as well. By way of example, an oversized image may exceed the size of area that houses the image. In this case, content manager 130 may choose to let the image auto-resize to fit into the area, align the image at one corner of the area without resizing the image, or center the image to the area, among many other options. In some embodiments, content manager 130 may request layout manger 110 to change the layout to accommodate the content. In one example, assume two areas are both with the nondeterministic size type and received equal space allocation initially. However, the first area is to house an image that exceeds its initial boundary, and the second area has sufficient unused space to lend to the first area. In this case, layout manger 110 may dynamically reallocate the space between the first area and the second area to accommodate the oversized image. The ratio of new space allocation between the first area and the second area may be based on the ratio of content hosted by these two areas.

Notification manager 140 enables system 100 to generate notifications based on user interactions with a UI element or an area of the UI. A natural layout hierarchy is formed after an area is recursively divided into subareas. Within a layout hierarchy, each leaf area can find its parent area, grandparent area, and so forth based on the division process. Further, in some embodiments, layout manager 110 assigns unique identifiers to each area in the layout. The identifiers can be used to uniquely identify the area that triggers a UI event. Further, based on the layout's hierarchical structure, notification manager 140 can also generate sequential relevant notifications for the area, its parent area, its grandparent area, and so forth. In some embodiments, two or more areas may be assigned with a same identifier. In this case, one or more areas may be parsed as the area(s) related to an UI event depending on the UI event and/or the logic for trigging the notification.

A notification may include the identifier of the area and the type of the user interaction, such as mouse over, mouse click, touch, double tapping, toggling, swiping, etc. The notification may trigger an action of system 100 or from another system. Notification manager 140 may generate sequential responses, including notification, in either direction, bottom-up or top-down. By way of example, a user interaction with a subarea may trigger a first notification. The user interaction may further trigger a second notification related to the parent area because the subarea is situated within the parent area. Such sequential responses may be generated in a bottom-up order.

In some embodiments, system 100 is a server computing device and/or service, such as a server and/or a service provided in a computing cloud, and interacts with other servers and/or services as well as various users. In alternative embodiments, system 100 or parts of system 100 can be integrated with a user computing device as a piece of hardware or software, such as embodied as a part of the operating system or an application (e.g., a browser).

In some embodiments, system 100 is embodied as a specialized computing device. In some embodiments, system 100 can be embodied, for example, as an application, a mobile application, or an online computing service. In some embodiments, system 100 can be a distributed system, for example, each of layout manager 110, UI manager 120, content manager 130, and notification manager 140 can be distributed across any number of computing devices. Regardless of the computing platform on which system 100 is implemented, system 100 can be embodied as a hardware component, a software component, or any combination thereof for layout design.

In other embodiments, systems for layout design can be implemented differently than that depicted in FIG. 1. As an example, UI manager 120 can be combined with notification manager 140 to form a comprehensive component to manage user interactions with UI elements. In some embodiments, components depicted in FIG. 1 have a direct or indirect connection not shown in FIG. 1. In this way, the components depicted in FIG. 1 can be connected in any number of ways and are not limited to the connections illustrated in FIG. 1. In some embodiments, some of the components depicted in FIG. 1 are divided into multiple components. Further, one or more components of system 100 can be located across any number of different devices and/or networks. As an example, content manager 130 can be implemented as an independent component in a computing cloud.

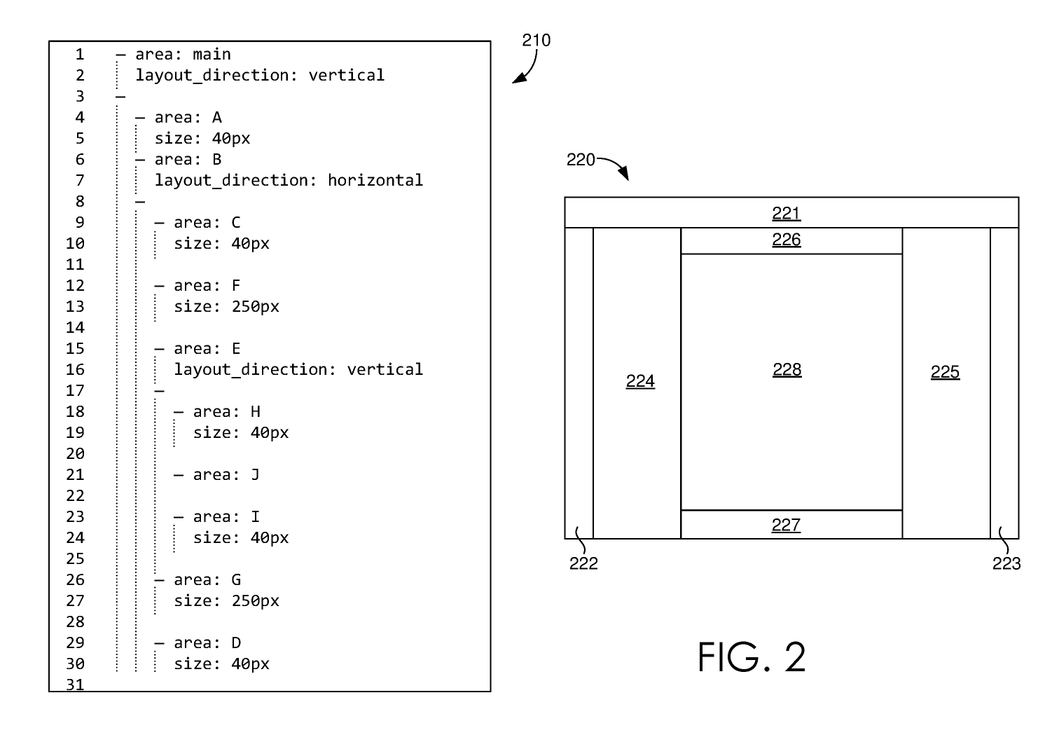

FIG. 2 is a schematic diagram illustrating an example layout design in accordance with one embodiment. Instruction 210 defines various areas and their arrangement in the UI. Layout 220 is generated based on instruction 210, e.g., by layout manger 110 of FIG. 1.

Layout 220 is the result of dividing the area identified as “main,” which is a unique identifier assigned to this area. Instruction 210 further defines the layout direction of the main area as vertical, which instructs the next level of subareas of the main area to be divided in the vertical direction, i.e., from top to bottom in this case.

The main area has two subareas, namely area A and area B according to instruction 210. Area A is implemented as subarea 221 in layout 220, and area B is further to be subdivided. Noticeably, area A is assigned with size 40 px, which means that area A is of a deterministic size type, and it should be allocated 40 pixels in the layout direction, i.e., vertically in this case.

The size of a deterministic size type may be represented corresponding to a parent area, such as a ratio of the parent area, e.g., 10%, 20%, and so forth. The size of a deterministic size type may be represented corresponding to the actual pixels on the screen or based on the physical size of the screen. For example, the size unit of pixel (px) refers to the actual pixels on the screen. The size unit of point (pt) refers to 1/72 of an inch based on the physical size of the screen. The size unit of density-independent pixels (dp) refers to an abstract unit that is based on the physical density of the screen. The size unit of scale-independent pixels (sp) is like the dp unit, but scaled by the user's font size preference. In some embodiments, different size units may be mixed in the layout instruction.

Instruction 210 does not define the size of area B. Area B will be assigned with the default size type, which is a nondeterministic size type in this case. Noticeably, instruction 210 assigns a different layout direction to area B. The layout direction of area B is altered from the layout direction of the main area, and becomes horizontal. Accordingly, when area B is further divided into areas C, F, E, G, and D, these subareas will be divided in the horizontal direction.

From left to right, area B will be divided into areas C, F, E, G, and D, in which areas C, F, G, and D are with the deterministic size type, and area E is with the nondeterministic size type. Accordingly, areas C, F, G, and D are implemented as areas 222, 224, 225, and 223, respectively, in layout 220 with deterministic sizes (40 px, 250 px, 250 px, and 40 px) in the horizontal dimension. Meanwhile, areas C, F, G, and D will take up the maximum size of area B in the vertical dimension.

Since area E is the only one with the nondeterministic size type among its sibling areas, area E will be allocated with the whole remaining space from area B. Subsequently, area E is further divided into areas H, J, and I, albeit the layout direction is changed back to vertical this time. Therefore, areas H, J and I are implemented as areas 226, 228, and 227 in layout 220. Areas 226, 228, and 227 are stacked from top to bottom according to the vertical layout direction. Areas 226 and 227 are each allocated with 40 px vertically, and area 228 is allocated with the remaining space.

The resulting layout forms a natural layout hierarchy. For example, the lineage of area J is main-B-E-J based on this layout process. Further, all leaf areas in layout 220 will completely occupy the main area as non-overlapping regions. There is at least one sibling subarea that is with the nondeterministic size type at the division. Such sibling subarea will take up the remaining space even though the overall size of the area to be divided can remain unknown. The designer only need to take care of the areas with the deterministic size type, and the layout system will handle the rest to completely allocate the remaining available space. This layout technique liberates the designer from matching up the sum of subareas with the area to be divided.

In this example, each area is assigned with an identifier. The starting area is called main, and the rest of the areas are named with a letter, A, B, C, and so forth. These unique identifiers may be utilized in a notification or response mechanism, and each unique identifier may uniquely represent the user interaction at a specific area. For example, in response to a user interaction associated with area 223 in layout 220, an event notification may be generated for the unique identifier D.

In this example layout design, an area may either inherit the layout direction of its parent area or be assigned a new layout direction different from the layout direction of its parent area. The further division of the area will follow the new layout direction. This layout technique provides designers the flexibility to change layout direction at any point of the layout hierarchy.

FIG. 3 is a schematic diagram illustrating another example layout design in accordance with one embodiment. Layout 320 is the result of implementing instruction 310, e.g., by layout manger 110 of FIG. 1. Layout 320 in FIG. 3 illustrates a layout technique for spacing and positioning objects.

Instruction 310 defines various areas and their arrangement in the UI. The starting area to be divided is identified as main with a vertical layout direction. All the subareas of the main area are divided vertically from top to bottom. There are some areas with the deterministic size type. Areas toolbar_photos, toolbar_search, and toolbar_feedback are each allocated with 40 dp in the vertical dimension. Noticeably, area spacer2 is allocated with 10 dp in the vertical dimension, which will be implemented as a narrow space 323 to separate area toolbar_photos and area toolbar_search.

Area spacer1 and area spacer3 are sibling areas with the nondeterministic size type of fill, which will allow them to share the remaining space of the main area equally. Resultantly, area toolbar_photos and area toolbar_search are positioned close to the center of the main area, but area toolbar_feedback is pushed to the bottom of the main area. Graphically, area 321 and area 325 in layout 320 are implemented to sandwich icon 322 and icon 324 to the center, and push icon 326 to the bottom.

Icons 322, 324, and 326 are different presentations of control UI elements, called icon_toggle_button. Each icon may toggle different images based on the user interaction. These toggle buttons are hosted in respective areas. User interactions with an area or the toggle button in the area will further trigger different notifications. For example, the user interaction with icon 322 will trigger the notification of photos. The user interaction with icon 324 will trigger the notification of search. The user interaction with icon 326 will trigger the notification of feedback.

This example layout illustrates a technique to generate a margin or a padding in the layout based on areas with the deterministic size type. Such areas for the margin or padding may not house any UI elements or content. In this embodiment, the deterministic size type is to define at least one dimension of an area with an arithmetic value, such as px in FIG. 2 or dp in FIG. 3. On the other hand, the nondeterministic size type is to fill an unallocated part of the area to be divided, such as area 321 and area 325 in layout 320.

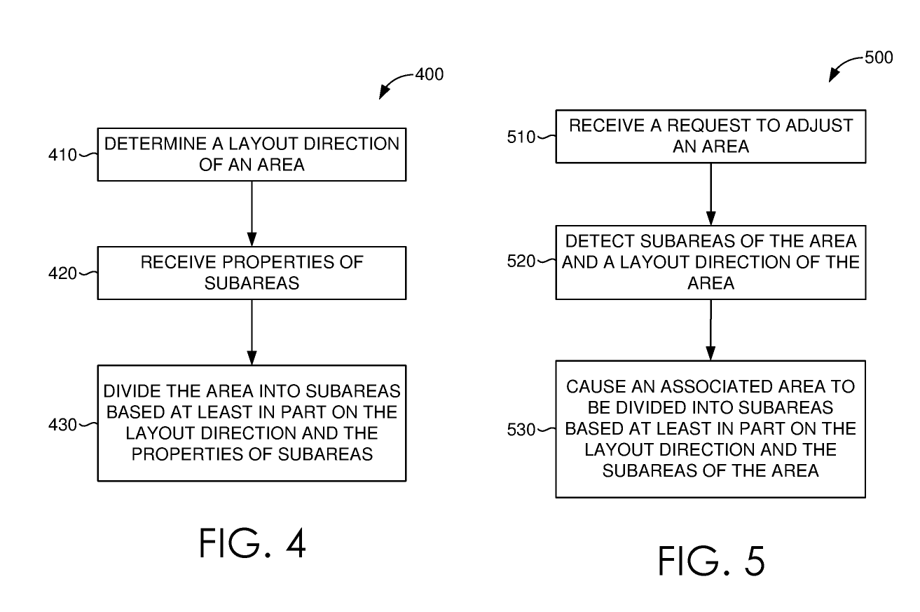

FIG. 4 is a flow diagram of an example process for layout design incorporating aspects of the present disclosure. Process 400 can be performed, for example, by system 100 of FIG. 1, to implement layout logics. Process 400 can be performed by processing logic that comprises hardware (e.g., circuitry, dedicated logic, programmable logic, microcode, etc.), software (e.g., instructions run on a processing device to perform hardware simulation), or a combination thereof. It will also be appreciated that, in various embodiments, process 400 can have fewer or additional operations than those depicted, or perform some of the depicted operations in a different order without departing from the scope of this disclosure.

In various embodiments, the process begins at block 410, where a layout direction of an area is determined, e.g., enabled by layout manager 110 of FIG. 1. The layout direction may be specified in any direction. For some layout designs, an absolute layout direction is specifically defined for an area, such as vertical, horizontal, or 45 degrees. In general, the vertical layout direction will arrange subareas from top to bottom. The horizontal layout direction will arrange subareas from left to right. The 45-degree layout direction will arrange subareas in the 45-degree direction. A subarea in the 45-degree direction may be transformed from an imaginary subarea in the vertical or horizontal direction, e.g., by matrix transformation or another technique for rotation. In some embodiments, the layout direction may be specified in any degree from 0 to 360 degrees.

For some layout designs, a relative layout direction is defined, such as a rotation from the layout direction of the parent area. As an example, a layout direction of +90 degrees means the new layout direction will rotate 90 degrees clockwise from the parent. As another example, a layout direction of −45 degrees means the new layout direction will rotate 45 degrees counter-clockwise from the parent.

In many cases, the layout direction is not specifically defined with the area. In this case, the lineage of the area will be searched, and the layout direction of the nearest ancestor area with a specified layout direction will be adopted. If such lineage search fails, a default layout direction may be used.

At block 420, properties of subareas may be received, e.g., by layout manager 110 of FIG. 1. In various embodiments, a subarea is a part of hierarchical nested areas. The subarea can inherit various properties from its parent area. Various properties may be inherited from the parent area, such as the shape of the area, the dimensions of the area, the layout direction, the background color, the background style, etc.

New properties may be added to the subareas. By way of example, the designer may add the size information to the subareas. The size information may include the size type and the actual size. The size type may include a deterministic size type or a nondeterministic size type. The actual size may include sizes in all dimensions of the subarea or just size information in one or more dimensions of the subarea.

When the shape of the area has only two dimensions, such as the first dimension being parallel to the layout direction and the second dimension being perpendicular to the first dimension, it is common to only specify the size for one dimension, and let the subarea inherit the maximum size in another dimension from its parent area. Similarly, when the area has more than two dimensions, it is feasible to leave sizes of one or more dimensions as unspecified. In that case, the subarea will inherit the sizes of the parent area in corresponding one or more dimensions.

The order of the subarea may also be received. Typically, the order of the subarea follows the natural sequence of subareas provided in the layout instruction. In some embodiments, the designer may specifically provide an order for subareas. For example, the layout instruction may provide an order number to each subarea. Accordingly, the layout manager will allocate available space based on the order numbers. If there is insufficient space, the order of subareas will serve as a priority guideline. The subareas at the top of the order list will be prioritized to receive allocations. The subareas at the bottom of the order list may or may not receive their requested allocation depending on the remaining space. Sometimes, the layout instruction may provide more complicated orders, such as an order depending on one or more conditions at run time. In this case, the layout manager will parse the layout instruction for the proper order at run time.

Next, at block 430, the area may be divided into subareas based at least in part on the layout direction and the properties of subareas, e.g., by layout manager 110 of FIG. 1. In general, the layout manager uses the requirements of a subarea and the layout direction to allocate the requisite space for the subarea. When there are multiple subareas, the layout manager also uses the order to arrange the subareas. For example, if the layout direction is vertical, the layout manager will arrange the subareas in their order from top to bottom. Similarly, if the layout direction is horizontal, the layout manager will arrange the subareas in their order from left to right.

However, in some embodiments, the vertical layout direction may direct the subareas to be arranged from bottom to top (BTT) to cater for a particular UI preference. Similarly, the horizontal layout direction may direct the subareas to be arranged from right to left (RTL). Such RTL arrangement order may be used for the layout designs with RTL languages, like Arabic, traditional Chinese, Hebrew, Persian, or Urdu. In those cases, a special instruction may be provided, such as RTL along the layout direction, so that the layout manager will implement the layout direction correctly.

If a subarea has a deterministic size type, the layout manager will allocate space based on the size requirements. If a subarea has a nondeterministic size type, the layout manager will allocate space based on the predetermined protocol for the nondeterministic size type. In connection with the layout example in FIG. 3, those subareas with the deterministic size type received respective allocations based on their size requirements, such as 40 dp or 10 dp in the layout direction. As only one dimension is specified for these subareas, the other dimension will inherit the maximum width of the parent area. For the two subareas with the nondeterministic size type, the default protocol is to equally divide the remaining space in the parent area to all sibling subareas of the nondeterministic size type.

In some embodiments, the protocol to divide the subareas with the nondeterministic size type is specifically defined by the designer. The designer of the UI may specify a non-equal division protocol. For example, a non-equal division protocol may allocate space in a diminishing fashion to favor one subarea over another subarea based on their relative positions in the order. In one instance, the first subarea with the nondeterministic size type may receive ½ of the remaining space, the second subarea with the nondeterministic size type may only receive ¼ of the remaining space, and so forth. Different non-equal division protocols may be used for different applications.

In some embodiments, another kind of nondeterministic size type, i.e., expandable, may be used. Further, the subarea may also specify the degree to expand the parent area. For instance, a subarea may indicate 110% as the expansion ratio. In this case, if the parent area runs out of space, e.g., when the sum of the areas with the deterministic size type is greater than the parent area, the parent area may expand 110% to accommodate all subareas.

The nondeterministic size type of expandable is useful for web page designs. A designer may include a subarea of expandable in either the vertical or horizontal layout direction. An expandable layout can host more content, and users may still be able to browse the content by scrolling the page. Besides the nondeterministic size types of fill and expandable, other nondeterministic size types may also be defined by designers in this layout system to achieve other functions.

FIG. 5 is a flow diagram of a second example process for layout design, incorporating aspects of the present disclosure. Process 500 can be performed, for example, by a system for layout design, e.g., system 100 of FIG. 1. Similar to process 400, process 500 can be performed by processing logic that comprises hardware (e.g., circuitry, dedicated logic, programmable logic, microcode, etc.), software (e.g., instructions run on a processing device to perform hardware simulation), or a combination thereof. It will also be appreciated that, in various embodiments, process 500 can have fewer or additional operations than those depicted, or perform some of the depicted operations in a different order without departing from the scope of this disclosure.

In various embodiments, the process begins at block 510, where a request to adjust an area is received. The request of adjusting the area may be generated from user interactions, such as when the user resizes a window. The request of adjusting the area may be generated by a computer event, such as when the display senses an orientation change, e.g., from portrait to landscape. The request of adjusting the area may also be generated due to content, such as when the dynamic content in the UI increases or decreases. Many other events may also generate such request.

At block 520, subareas of the area and a layout direction of the area may be detected. The present UI will be the base UI for adjustment. The layout manager will detect the layout direction of the area and various properties of the subareas of the area, e.g., from the layout instructions associated with the present layout. The properties of a subarea may include its shape, size type, size, etc.

Next, at block 530, an associated area in a new UI may be divided into subareas based at least in part on the layout direction and the subareas of the area. In response to the request to adjust the area, the layout manger will generate a new layout for the new UI. By way of example, when the display switches from portrait to landscape mode, the layout manger will reassess the parent area and divide the parent area into the subareas based at least in part on the layout direction of the parent area and the size requirements of the subareas. Generally, the layout direction of the parent area in the new UI will remain the same. For a subarea with a deterministic size type, at least one dimension of the subarea will be kept unchanged in the new UI. However, for a subarea with a nondeterministic size type, at least two dimensions of the subarea may be changed to adapt to the new UI. When the request to adjust the area is associated with an action to resize the parent area, the layout manager may similarly adjust the layout for the new UI.

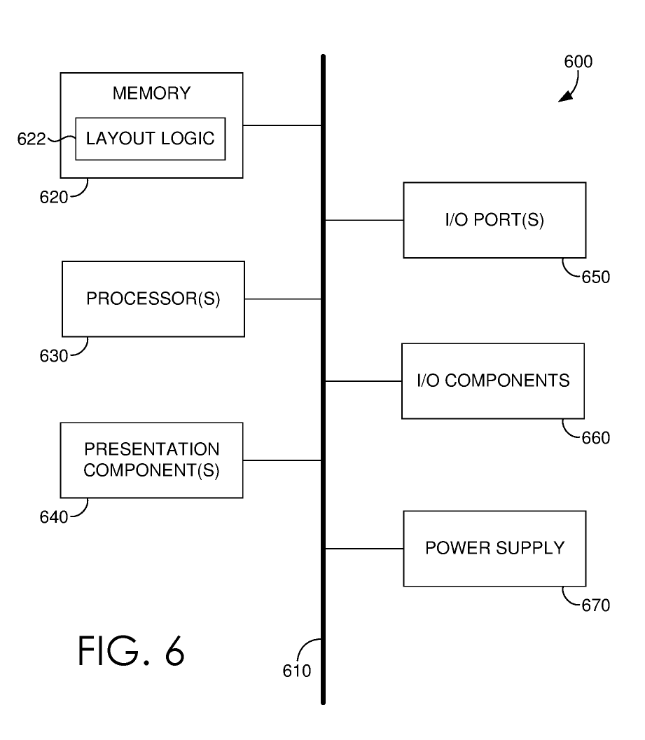

Having briefly described an overview of embodiments of the present invention, an exemplary operating environment in which embodiments of the present invention is to be implemented is described below in order to provide a general context for various aspects of the present invention. Referring initially to FIG. 6 in particular, an exemplary operating environment for implementing embodiments of the present invention is shown and designated generally as computing device 600. Computing device 600 is but one example of a suitable computing environment and is not intended to suggest any limitation as to the scope of use or functionality of the invention. Neither should the computing device 600 be interpreted as having any dependency or requirement relating to any one or combination of components illustrated.

The disclosure is described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The embodiments of this disclosure are to be practiced in a variety of system configurations, including handheld devices, consumer electronics, general-purpose computers, more specialty computing devices, etc. The embodiments of this disclosure are to be practiced in distributed computing environments where tasks are performed by remote-processing devices that are linked through a communications network.

With reference to FIG. 6, computing device 600 includes a bus 610 that directly or indirectly couples the following devices: memory 620, one or more processors 630, one or more presentation components 640, input/output (I/O) ports 650, input/output (I/O) components 660, and an illustrative power supply 670. Bus 610 represents one or more busses (such as an address bus, data bus, or combination thereof). Although the various blocks of FIG. 6 are shown with lines for the sake of clarity, in reality, delineating various components is not so clear, and metaphorically, the lines would more accurately be fuzzy. For example, a presentation component such as a display device could also be considered as an I/O component. Also, processors have memory. The inventor recognizes that such is the nature of the art, and reiterates that the diagram of FIG. 6 is merely illustrative of an exemplary computing device that is used in connection with one or more embodiments of the present invention. Distinction is not made between such categories as “workstation,” “server,” “laptop,” “handheld device,” etc., as all are contemplated within the scope of FIG. 6 and reference to “computing device.”

Computing device 600 typically includes a variety of computer-readable media. Computer-readable media include any available media to be accessed by computing device 600, and include both volatile and nonvolatile media, and removable and non-removable media. By way of example, and not limitation, computer-readable media comprises computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which is used to store the desired information and which is accessed by computing device 600. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 620 includes computer storage media in the form of volatile and/or nonvolatile memory. In various embodiments, the memory is removable, non-removable, or a combination thereof. Exemplary hardware devices include solid-state memory, hard drives, optical-disc drives, etc. Computing device 600 includes one or more processors 630 that read data from various entities such as memory 620 or I/O components 660. Presentation component(s) 640 present data indications to a user or other device. Exemplary presentation components include a display device, speaker, printing component, vibrating component, etc.

In various embodiments, memory 620 includes, in particular, temporal and persistent copies of layout logic 622. Layout logic 622 includes instructions that, when executed by one or more processors 630, result in computing device 600 to provide a layout, such as, but not limited to, layout designs in FIG. 2 or 3, or perform a process, such as, but not limited to, process 400 or process 500. In various embodiments, layout logic 622 includes instructions that, when executed by processors 630, result in computing device 600 performing various functions associated with, but not limited to, layout manager 110, UI manager 120, content manager 130, or notification manager 140 in connection with FIG. 1.

In some embodiments, one or more processors 630 are to be packaged together with layout logic 622. In some embodiments, one or more processors 630 are to be packaged together with layout logic 622 to form a System in Package (SiP). In some embodiments, one or more processors 630 are integrated on the same die with layout logic 622. In some embodiments, processors 630 are integrated on the same die with layout logic 622 to form a System on Chip (SoC).

I/O ports 650 allow computing device 600 to be logically coupled to other devices including I/O components 660, some of which are built-in components. Illustrative components include a microphone, joystick, game pad, satellite dish, scanner, printer, wireless device, etc. In some embodiments, the I/O components 660 also provide a natural user interface (NUI) that processes air gestures, voice, or other physiological inputs generated by a user. In some embodiments, inputs are to be transmitted to an appropriate network element for further processing. An NUI implements any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 is equipped with depth cameras, such as stereoscopic camera systems, infrared camera systems, RGB camera systems, touchscreen technology, and combinations of these, for gesture detection and recognition. Additionally, the computing device 600 is equipped with accelerometers or gyroscopes that enable detection of motion. The output of the accelerometers or gyroscopes is to be provided to the display of the computing device 600 to render immersive augmented reality or virtual reality.

Although certain embodiments have been illustrated and described herein for purposes of description, a wide variety of alternate and/or equivalent embodiments or implementations calculated to achieve the same purposes could be substituted for the embodiments shown and described without departing from the scope of the present disclosure. This application is intended to cover any adaptations or variations of the embodiments discussed herein. Therefore, it is manifestly intended that embodiments described herein be limited only by the claims.

What is claimed is:

1. A computer-implemented method, comprising:
receiving information of a first component of a deterministic size type, information of a second component of a nondeterministic size type, and an order of the first component and the second component;
determining a layout direction of an area; and
dividing the area into a plurality of subareas based at least in part on the layout direction, the first component of the deterministic size type, the second component of the nondeterministic size type, and the order between the first component and the second component.

2. The method of claim 1, further comprising:
assigning an identifier to a subarea allocated to the first component; and
in response to a user interaction associated with the subarea, generating an event notification including the identifier.

3. The method of claim 1, further comprising:
receiving a different layout direction for the second component, the different layout direction being different from the layout direction of the area; and
dividing the second component into two or more subareas according to the different layout direction.

4. The method of claim 1, wherein the dividing comprises allocating a part of the area with a size of the first component to the first component, and a remaining part of the area to the second component, the part and the remaining part being aligned in the layout direction of the area according to the order of the first component and the second component.

5. The method of claim 1, wherein the dividing comprises allocating remaining parts of the area in equal size to sibling components of the nondeterministic size type.

6. The method of claim 1, wherein the first component comprises a first dimension and a second dimension, the first dimension being parallel to the layout direction of the area, the second dimension being perpendicular to the first dimension, the first dimension having a user-defined size, the second dimension inheriting a maximum size of the area at the second dimension.

7. The method of claim 1, wherein the plurality of subareas completely occupies the area as non-overlapping regions based at least in part on one subarea of the plurality of subareas being allocated to the second component of the nondeterministic size type.

8. The method of claim 1, wherein the deterministic size type comprises a predetermined value for at least one dimension of a subarea, or a ratio of a dimension of the area.

9. The method of claim 1, wherein the nondeterministic size type is fill, and the second component is to fill an unallocated part of the area.

10. The method of claim 1, wherein the area is a part of hierarchical nested areas, and the area inherits a plurality of properties from a parent area of the hierarchical nested areas, wherein the plurality of properties includes a layout direction.

11. The method of claim 10, wherein the hierarchical nested areas form a part of a graphical user interface, and the method further comprising:
generating a user interface element for each of leaf areas of the hierarchical nested areas in the graphical user interface.

12. One or more computer storage devices comprising computer-implemented instructions that, when used by one or more computing devices, cause the one or more computing devices to:
receive a request to adjust an area associated with a first form of a graphical user interface;
detect a first component and a second component of the area, and a layout direction of the area associated with the first form of the graphical user interface, the first component having a deterministic size type, the second component having a nondeterministic size type; and
in response to the request to adjust the area, cause an associated area of a second form of the graphical user interface to be divided into a plurality of subareas based at least in part on the first component of the deterministic size type, the second component of the nondeterministic size type, and the layout direction of the area.

13. The one or more computer storage devices of claim 12, wherein the request to adjust the area is associated with an orientation change of the graphical user interface from the first form of the graphical user interface to the second form of the graphical user interface, the instructions further cause the one or more computing devices to:
keep a layout direction of the associated area in the second form of the graphical user interface be consistent with the layout direction of the area in the first form of the graphical user interface.

14. The one or more computer storage devices of claim 12, the instructions further cause the one or more computing devices to:
keep at least one dimension of the first component unchanged in the second form of the graphical user interface compared with the first form of the graphical user interface; and
change at least two dimensions of the second component in the second form of the graphical user interface compared with the first form of the graphical user interface.

15. The one or more computer storage devices of claim 12, wherein the request to adjust the area is associated with an action to resize the area, the instructions further cause the one or more computing devices to:
allocate a part of the associated area with a size of the first component to the first component, and an unallocated part of the associated area to the second component, wherein the part and the unallocated part are aligned in the layout direction of the area following an order of the first component and the second component associated with the first form of the graphical user interface.

16. The one or more computer storage devices of claim 12, the instructions further cause the one or more computing devices to:
allocate remaining parts in the associated area in equal size to sibling components of the nondeterministic size type.

17. The one or more computer storage devices of claim 12, the instructions further cause the one or more computing devices to:
generate a margin or a padding based on a third component of the deterministic size type, wherein the deterministic size type is to define at least one dimension of a component with an arithmetic value.

18. A system, comprising:
means for receiving information of a first component of a deterministic size type, information of a second component of nondeterministic size type, and an order of the first component and the second component;
means for determining a layout direction of an area; and
means for dividing the area into a plurality of subareas based at least in part on the layout direction, the first component of the deterministic size type, the second component of the nondeterministic size type, and the order between the first component and the second component.

19. The system of claim 18, wherein the area is a part of hierarchical nested areas, and the area inherits a plurality of properties from a parent area containing the area, the plurality of properties including the layout direction being vertical or horizontal.

20. The system of claim 19, further comprising:
means for altering the layout direction of the area.
